(19) United States
(12) Patent Application Publication
(10) Pub. No.: US 2012/0230259 A1
(43) Pub. Date: Sep. 13, 2012

(54) ACCESSING SERVICE INFORMATION

(75) Inventors: Jarkko Kneckt, Espoo (FI); Klaus Doppler, Espoo (FI)

(73) Assignee: Nokia Corporation, Espoo (FI)

(21) Appl. No.: 13/508,584

(22) PCT Filed: Nov. 11, 2009
(86) PCT No.: PCT/FI2009/050906

§ 371 Date: May 8, 2012

(51) Int. Cl. H04W 4/00

(52) U.S. Cl. 370/328

(57) ABSTRACT

First, second and third apparatuses, methods and computer programs are provided. The first apparatus (10) controls a transmitter to transmit, to the third apparatus (30), service information relating to at least one service. The first apparatus (10) also controls the transmitter to transmit, to the third apparatus (30), at least one access control parameter that defines how to control access to the service information. The second apparatus (20) controls a transmitter to transmit a request, to the third apparatus (30) via data link layer signaling, requesting access to service information. The request comprises at least one access request parameter. The third apparatus (30) determines, from at least one access control parameter provided by the first apparatus (10), how to control access to service information provided by the first apparatus (10). The third apparatus (30) decides, in response to reception of the request from the second apparatus (20), whether to enable the second apparatus (20) to access service information provided by the first apparatus (10). The decision is dependent upon the at least one access control parameter. In response to deciding to enable the second apparatus (20) to access service information provided by the first apparatus (10), the third apparatus (30) controls a transmitter to transmit, via data link layer signaling, that service information to the second apparatus (20).

### FIELD

Embodiments of the present invention relate to services. In particular, they relate to providing service information and controlling access to service information.

### BACKGROUND

A user of a first apparatus may wish to determine which services (if any) are provided by local networks. A scan may determine that several local networks are present.

In order to determine which services are provided by a particular one of those networks, the first apparatus establishes an Internet Protocol (IP) network connection (or other network layer connection) with that network. It may be necessary to carry out synchronization, authentication and IP address creation processes before the connection is established.

Once an IP connection has been established, information may then be provided to the first apparatus that indicates the services that are provided by the network. For example, the network may provide printing services or displaying services.

However, in some situations, the user may have to connect the first apparatus to several networks before he finds the service that he is looking for. Establishment of an IP connection with each network takes time, so it can be a while before a desired service is found.

### BRIEF DESCRIPTION OF VARIOUS EMBODIMENTS OF THE INVENTION

According to various, but not necessarily all, embodiments of the invention, there is provided a method, comprising: controlling a transmitter of an apparatus to transmit a request, to a further apparatus via data link layer signaling, requesting access to service information relating to at least one service and provided to the further apparatus by at least one other apparatus, wherein the request comprises at least one access request parameter.

According to various, but not necessarily all, embodiments of the invention, there is provided an apparatus, comprising: at least one memory for storing at least one access request parameter; and control circuitry configured to control a transmitter to transmit a request, to a further apparatus via data link layer signaling, requesting access to service information relating to the at least one service and provided to the further apparatus by at least one other apparatus, wherein the request comprises the at least one access request parameter.

According to various, but not necessarily all, embodiments of the invention, there is provided a computer program comprising computer program instructions that, when executed by at least one processor, enable: controlling a transmitter of an apparatus to transmit a request, to a further apparatus via data link layer signaling, requesting access to service information relating to at least one service and provided to the further apparatus by at least one other apparatus, wherein the request comprises at least one access request parameter.

According to various, but not necessarily all, embodiments of the invention, there is provided a method, comprising: controlling a transmitter of an apparatus to transmit, to a further apparatus, service information relating to at least one service; and controlling the transmitter of the apparatus to transmit, to the further apparatus, at least one access control parameter that defines how to control access, via data link layer signaling, to the service information relating to the at least one service.

According to various, but not necessarily all, embodiments of the invention, there is provided an apparatus, comprising: at least one memory for storing at least one access control parameter that defines how to control access to service information relating to at least one service; control circuitry configured to control a transmitter to transmit, to a further apparatus, the service information relating to at least one service, wherein the control circuitry is further configured to control the transmitter to transmit, to the further apparatus, the at least one access control parameter that defines how to control access, via data link layer signaling, to the service information relating to the at least one service.

According to various, but not necessarily all, embodiments of the invention, there is provided an apparatus, comprising: means for controlling a transmitter of an apparatus to transmit, to a further apparatus, service information relating to at least one service; and means for controlling the transmitter of the apparatus to transmit, to the further apparatus, at least one access control parameter that defines how to control access, via data link layer signaling, to the service information relating to the at least one service.

According to various, but not necessarily all, embodiments of the invention, there is provided a computer program comprising computer program instructions that, when executed by at least one processor, enable: controlling a transmitter of an apparatus to transmit, to a further apparatus, service information relating to at least one service; and controlling the transmitter of the apparatus to transmit, to the further apparatus, at least one access control parameter that defines how to control access, via data link layer signaling, to the service information relating to the at least one service.

According to various, but not necessarily all, embodiments of the invention, there is provided a method, comprising: determining, from at least one access control parameter provided by a first apparatus, how to control access to service information provided by the first apparatus; and deciding, in response to reception of a request from a second apparatus requesting access to service information, whether to enable the second apparatus to access service information provided by the first apparatus, wherein the decision is dependent upon the at least one access control parameter; and in response to deciding to enable the second apparatus to access service information provided by the first apparatus, controlling a transmitter to transmit, via data link layer signaling, that service information to the second apparatus.

According to various, but not necessarily all, embodiments of the invention, there is provided an apparatus, comprising: determination circuitry configured to determine from at least one access control parameter provided by a further apparatus, how to control access to the service information provided by the further apparatus; decision circuitry configured to decide, in response to reception of a request from another apparatus requesting access to service information, whether to enable the another apparatus to access service information provided by the further apparatus, wherein the decision is dependent upon the at least one access control parameter; and control circuitry configured, in response to the decision circuitry deciding to enable the another apparatus to access service information provided by the further apparatus, to control a transmitter to transmit, via data link layer signaling, that service information to the another apparatus.

According to various, but not necessarily all, embodiments of the invention, there is provided an apparatus, comprising: means for determining, from at least one access control parameter provided by a further apparatus, how to control access to service information provided by the further apparatus; means for deciding, in response to reception of a request from another apparatus requesting access to service information, whether to enable the another apparatus to access service information provided by the further apparatus, wherein the decision is dependent upon the at least one access control parameter; and means for controlling, in response to deciding to enable the another apparatus to access service information provided by the further apparatus, a transmitter to transmit, via data link layer signaling, that service information to the another apparatus.

According to various, but not necessarily all, embodiments of the invention, there is provided a computer program comprising computer program instructions that, when executed by at least one processor, enable: determining, from at least one access control parameter provided by a first apparatus, how to control access to service information provided by the first apparatus; and deciding, in response to reception of a request from a second apparatus requesting access to service information, whether to enable the second apparatus to access service information provided by the first apparatus, wherein the decision is dependent upon the at least one access control parameter; and in response to deciding to enable the second apparatus to access service information provided by the first apparatus, controlling a transmitter to transmit, via data link layer signaling, that service information to the second apparatus.

### BRIEF DESCRIPTION OF THE DRAWINGS

For a better understanding of various examples of embodiments of the present invention reference will now be made by way of example only to the accompanying drawings in which:

FIG. 1A illustrates an exemplary first apparatus;

FIG. 1B illustrates an exemplary second apparatus;

FIG. 1C illustrates an exemplary third apparatus;

FIG. 2 illustrates a system including the exemplary first, second and third apparatuses;

FIG. 3 illustrates a method;

FIG. 4A illustrates a further exemplary first apparatus;

FIG. 4B illustrates a further exemplary second apparatus;

FIG. 4C illustrates a further exemplary third apparatus; and

FIG. 5 illustrates a system including the further exemplary first, second and third apparatuses.

### DETAILED DESCRIPTION OF VARIOUS EMBODIMENTS OF THE INVENTION

In embodiments of the invention, first and second apparatuses may be potential participants in a service. The service may, for example, be provided by the first apparatus or by a server. The first apparatus controls transmission of service information and one or more access control parameters to a third apparatus. The service information may, for example, be associated with the first apparatus. The one or more access control parameters define how to control access to the service information.

The second apparatus generates a request, for transmission to the third apparatus, requesting access to service information. The request includes one or more access request parameters. The request is transmitted using data link layer signaling.

The third apparatus decides, in response to reception of the generated request, whether to enable the second apparatus to access to service information provided by the first apparatus. The decision is dependent upon the one or more access control parameters provided by the first apparatus and in addition it may be dependent upon the one or more access request parameters provided by the second apparatus. In response to deciding to enable the second apparatus to access the service information, the third apparatus controls a transmitter to transmit the service information to the second apparatus, via data link layer signaling.

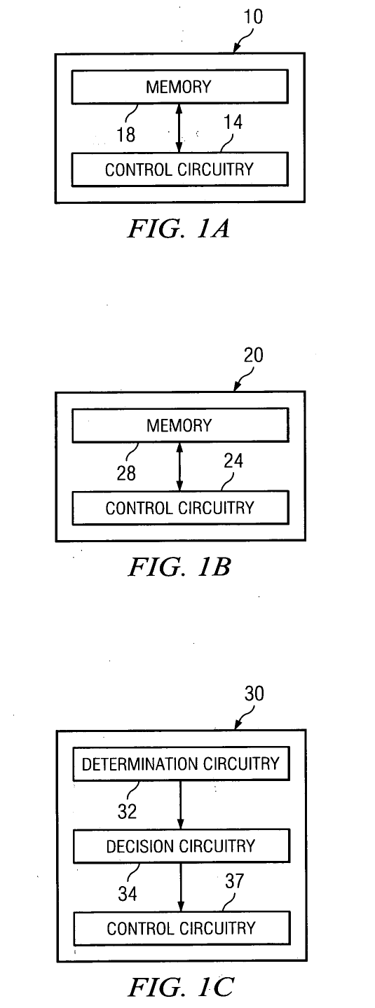

FIG. 1A illustrates an exemplary first apparatus 10. The first apparatus 10 may be an electronic device. For example, the first apparatus 10 may be a mobile telephone, a computer, a display or a printer. Alternatively, the first apparatus 10 may be a chip or a chipset for an electronic device.

The illustrated first apparatus 10 comprises a memory 18 and control circuitry 14. The control circuitry 14 may be provided by processing circuitry comprising one or more processors. The control circuitry 14 may be configured to read from and write to the memory 18.

The memory 18 is for storing one or more access control parameter that define how to control access to service information relating to least one service. In some implementations, the access control parameter(s) may be generated and stored (in the memory 18) by the control circuitry 14 when the first apparatus 10 is in use.

The control circuitry 14 is configured to control a transmitter to transmit service information relating to one or more services. The first apparatus 10 may be the service provider for the one or more services. For example, the first apparatus 10 may control access to the one or more services, and usage of the one or more services. In alternative implementations, the first apparatus 10 does not provide the one or more services and has merely registered or subscribed to the one or more services. In these implementations, the one or more services may be provided by a server.

The service information may identify the service(s). The service information may, for example, be transmitted (for instance, uploaded) to a support node of a radio communications network. For example, the service may be a social networking service, a printing service or a displaying service. The social networking service may, for example, relate to dating or a secret club.

The service information may, for example, provide information about the first apparatus 10 or its user. The service information may, for example, identify one or more characteristics of the first apparatus 10 or its user. For instance, if the service is a social networking service, the service information may comprise user profile data identifying one or more characteristics of a user/owner of the first apparatus 10. For instance, the identified characteristics may include: his or her sex, age, height, weight, eye color, hair color, schools and colleges attended, current job role etc.

The service information may, for example, comprise communication information that enables other apparatuses to communicate with the service provider of the service that the service information relates to. The service provider may be the first apparatus 10 or another apparatus.

The communication information may comprise data identifying one or more characteristics of the first apparatus 10 or another apparatus, such as the communication protocols that the first apparatus 10 (or the other apparatus) is compatible with. The communication information may also include authentication information. The authentication information may, for instance, include an authentication key that enables another apparatus to communicate with the first apparatus 10 (or the other apparatus). It may be that it is not possible to use the service and/or control the first apparatus 10 (or the other apparatus) without some or all of the communication information.

For instance, if the first apparatus 10 is a display or a printer, the communication information may enable another apparatus to control the first apparatus 10 to display or print information. Without access to the communication information, it may not be possible to use the first apparatus 10 to display or print information.

The control circuitry 14 is further configured to control a transmitter to transmit the one or more access control parameters (for example, to a support node of a radio communications network). The access control parameter(s) define how to control access to the service information. For example, the one or more access control parameters may define one or more conditions to be fulfilled, in order for an apparatus to be granted access to the service information. The access control parameter(s) may, for example, define one or more conditions to be fulfilled in order for the service information to be re- transmitted by an apparatus (such as the support node).

The one or more conditions may, for example, specify that another apparatus (and/or its user/owner), must have one or more characteristics in order to access the service information. The one or more characteristics required by the condition(s) in the access control parameter(s) may be the same or different to the characteristics identified in the service information (which relate to the first apparatus 10 or its user).

For instance, consider an example in which the service is a social networking service. A user of the first apparatus 10 may be interested in meeting other people of that have particular characteristic (for example, people having a similar educational background or job role). In this case, the conditions defined by the access control parameters may specify that only people having the required characteristics (such as a particular educational background or job role) may access the service information relating to the use of the first apparatus 10.

In an alternative example, the characteristic(s) required by the access control parameter(s) may be that an apparatus has one or more specified identifiers (for instance, medium access control addresses, IP addresses, mobile subscriber identification numbers, or other subscriber or apparatus identifiers). In this example, only apparatuses having a specified identifier are allowed to use the service.

FIG. 1B illustrates an exemplary second apparatus 20. The second apparatus 20 may be an electronic device. For example, the second apparatus 20 may be a portable electronic device such as a mobile telephone, a notebook computer, a netbook, a personal digital assistant or a personal music player. Alternatively, the second apparatus 20 may be a chip or a chipset for an electronic device.

The illustrated second apparatus 20 comprises a memory 28 and control circuitry 24. The control circuitry 24 may be provided by processing circuitry comprising one or more processors.

The memory 28 is for storing at least one or more access request parameters. In some implementations, the access request parameter(s) may be generated and stored (in the memory 28) by the control circuitry 24 when the second apparatus 20 is in use. In other implementations, the access request parameters(s) may be generated and stored during manufacture of the second apparatus 20.

The control circuitry 24 is configured to generate a request requesting access to service information.

The control circuitry 24 is further configured to control a transmitter to transmit the request via data link layer signaling. The request may, for example, be transmitted to a support node of a radio communications network. The request may comprise at least one access request parameter.

The access request parameter(s) may, for example, identify one or more characteristics of the second apparatus 20 or the owner/user of the second apparatus 20.

If, for example, the service is a social networking service, the access request parameter(s) may indicate one or more of the following characteristics of the user: his or her sex, age, height, weight, eye color, hair color, educational background, current job role etc.

Alternatively or additionally, the one or more characteristics may specify one or more identifiers of the second apparatus 20 (such as a medium access control address, an IP address, a mobile subscriber identification number, or another subscriber or apparatus identifier).

FIG. 10 illustrates an exemplary third apparatus 30. The third apparatus 30 may, for example, be a support node of a radio communications network or a server in the internet. Alternatively, the third apparatus 30 may be a chip or a chipset for a support node of a radio communications network. The illustrated third apparatus 30 comprises determination circuitry 32, decision circuitry 34 and control circuitry 37.

The determination circuitry 32, the decision circuitry 34 and the control circuitry 37 may be provided by processing circuitry comprising one or more processors. For example, the functions performed by the determination circuitry 32, the decision circuitry 34 and the control circuitry 37 may be performed by the same processor, or different processors.

The determination circuitry 32 is configured to determine, from the one or more access control parameters provided by the first apparatus 10, how to control access to the service information provided by the first apparatus 10. The service information may, for example, be stored in a memory of the third apparatus 30.

The decision circuitry 34 is configured to decide, in response to the reception of the request from the second apparatus 20, whether to enable the second apparatus 20 to access the service information provided by the first apparatus 10. The decision is dependent upon the one or more access control parameters provided by the first apparatus 10 and in addition it may be dependent upon the one or more access request parameters included in the request.

The decision circuitry 34 may, for example, decide whether to enable the second apparatus 20 to access the service information by determining whether the one or more access request parameters fulfill conditions defined by the one or more access control parameters. If the conditions are fulfilled, the decision circuitry 34 enables the second apparatus 20 to access the service information. If the conditions defined by the one or more access control parameters are not fulfilled, the decision circuitry 34 may deny the second apparatus 20 access to the service information.

The control circuitry 37 is configured, in response to the decision circuitry 34 deciding to enable the second apparatus 20 to access the service information, to control a transmitter to transmit, via data link layer signaling, the service information to the second apparatus 20.

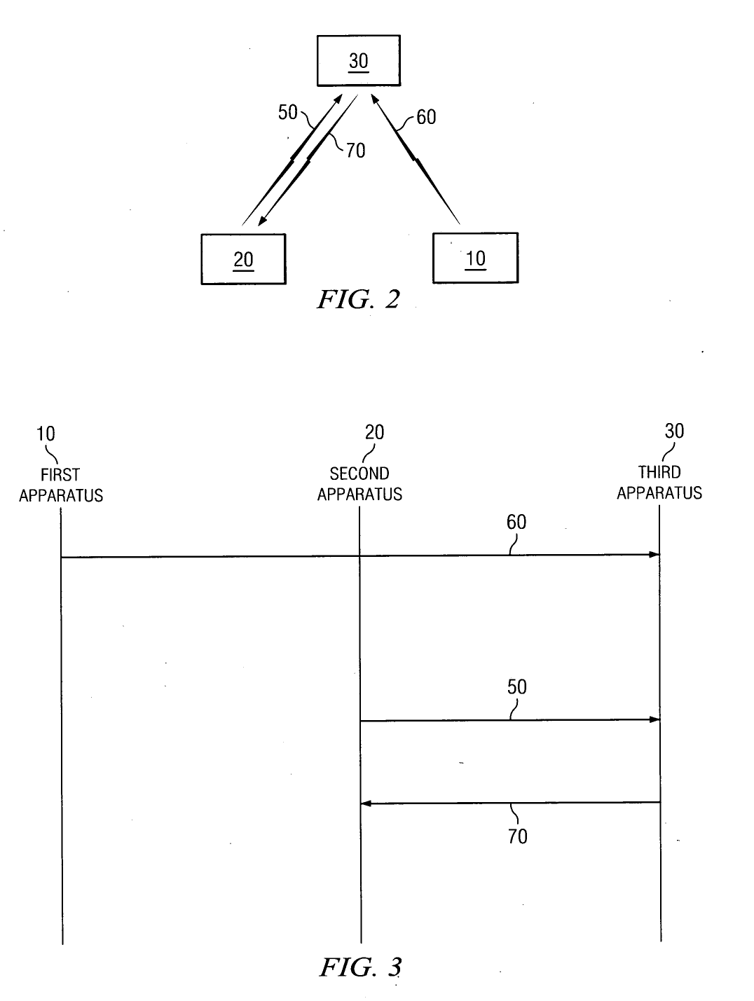

FIG. 2 illustrates a system including the first, second and third apparatuses 10, 20, 30. FIG. 3 illustrates a method.

FIG. 2 and FIG. 3 illustrate the first apparatus 10 controlling a transmitter to transmit a first signal 60, including service information and the one or more access control parameters. The first signal 60 is transmitted to the third apparatus 30.

The third apparatus 30 determines, from the one or more access control parameters included in the first signal 60, how to control access to the service information provided by the first apparatus 10.

The second apparatus 20 controls a transmitter to transmit a second signal 50, using data link layer signaling, that includes the request. The request may include the access request parameter(s).

The third apparatus 30 decides, in response to reception of the second signal 50, whether to enable the second apparatus 20 to access the service information. The decision is dependent upon the access control parameter(s) previously provided by the first apparatus 10, and in addition it may be dependent upon the access request parameter(s) included in the request.

In response to deciding to enable the second apparatus 20 to access the service information, the third apparatus 30 controls a transmitter to transmit a third signal 70. The third signal 70 includes some or all of the service information provided by the first apparatus 10, and is transmitted using data link layer signaling.

As mentioned above, the service information may include communication information that enables an apparatus to communicate with a service provider. If the service information does not comprise the communication information, the third apparatus 30 may control a transmitter to transmit such communication information in addition to the service information.

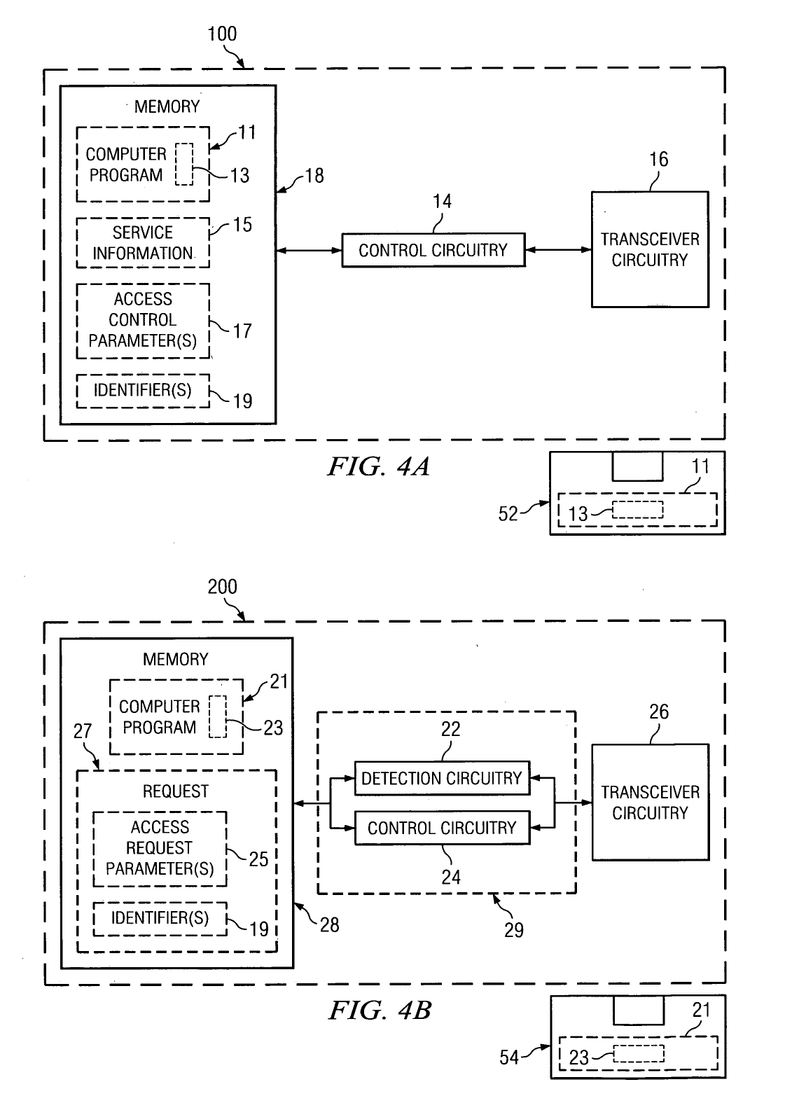

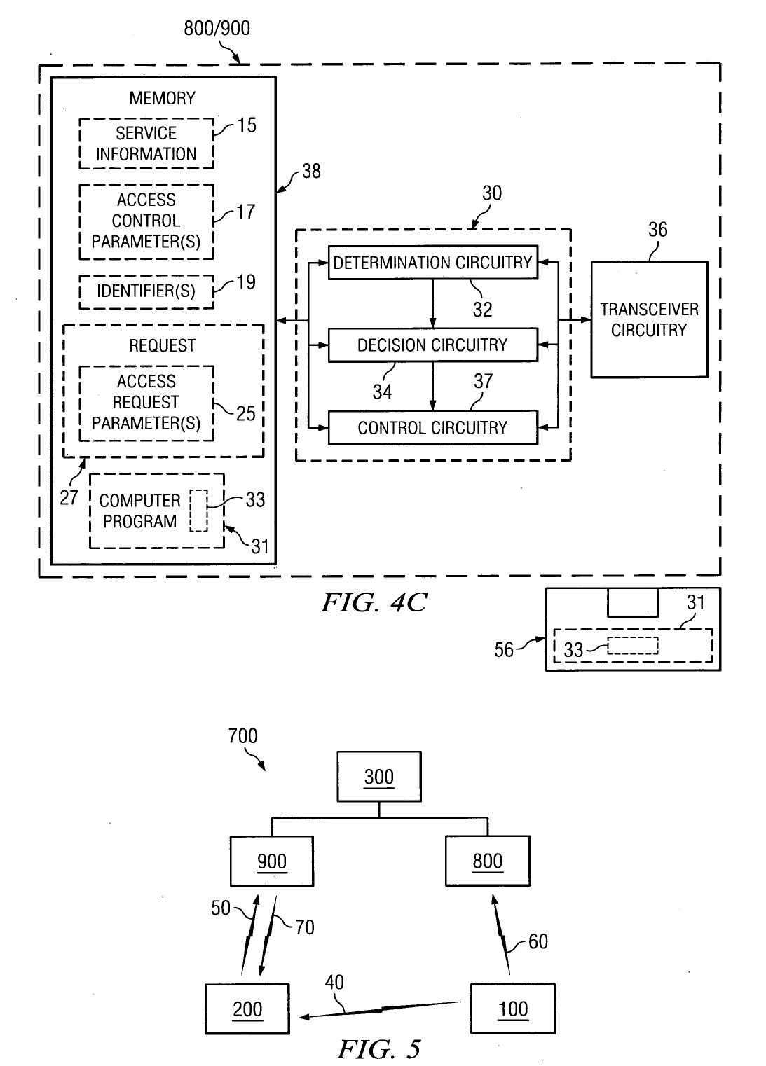

FIG. 4A illustrates a further example of a first apparatus 100. The first apparatus 100 illustrated in FIG. 4A comprises the control circuitry 14 and the memory 18 of the apparatus 10 illustrated in FIG. 1A, and also comprises transceiver circuitry 16. The first apparatus 100 illustrated in FIG. 4A may be an electronic device such as a mobile telephone, a computer, a display device, a printer device or a combination of these items.

The transceiver circuitry 16 is configured to transmit and receive radio signals. The radio signals may be short range radio signals or long range radio signals. The transceiver circuitry 16 is configured to operate as a transmitter and a receiver. The transceiver circuitry 16 may operate, for example, in accordance with an 802.11 Institute of Electronic Engineers (IEEE) protocol or a Bluetooth protocol.

The memory 18 is illustrated in FIG. 4A as storing a computer program 11, service information 15, one or more access control parameters 17 and one or more identifiers 19.

Although the memory 18 is illustrated as a single component it may be implemented as one or more separate components some or all of which may be integrated/removable and/or may provide permanent/semi-permanent/ dynamic/cached storage.

In the FIG. 4A implementation, the computer program 11 comprising computer program instructions 13 controls the operation of the first apparatus 100 when loaded into the control circuitry 14. The computer program instructions 11 provide the logic and routines that enables the first apparatus 100 to perform aspects of the method illustrated in FIG. 3. The control circuitry 14 by reading the memory 18 is able to load and execute the computer program 11.

The computer program 11 may arrive at the first apparatus 100 via any suitable delivery mechanism 52. The delivery mechanism 52 may be, for example, a computer-readable storage medium, a computer program product, a memory device, a record medium such as a CD-ROM or DVD, an article of manufacture that tangibly embodies the computer program 11. The delivery mechanism 52 may be a signal configured to reliably transfer the computer program 11. The first apparatus 100 may propagate or transmit the computer program 11 as a computer data signal.

FIG. 4B illustrates a further example of a second apparatus 200. The second apparatus 200 illustrated in FIG. 4B comprises the control circuitry 24 and the memory 28 of the apparatus 20 illustrated in FIG. 1 B, and also detection circuitry 22 and transceiver circuitry 26.

The second apparatus 200 illustrated in FIG. 4B may be a portable electronic device such as a mobile telephone, a notebook computer, a netbook, a personal digital assistant or a personal music player. The detection circuitry 22 and the control circuitry 24 may be provided by processing circuitry 29 comprising one or more processors. The processing circuitry 29 is configured to provide an output to and receive an input from the transceiver circuitry 26. The processing circuitry 29 is also configured to read from and write to the memory 28.

The transceiver circuitry 26 is configured to transmit and receive radio signals. The radio signals may be short range radio signals or long range radio signals. The transceiver circuitry 26 is configured to operate as a transmitter and a receiver. The transceiver circuitry 26 may operate, for example, in accordance with an 802.11 Institute of Electronic Engineers (IEEE) protocol or a Bluetooth protocol.

The memory 28 is illustrated in FIG. 4B as storing a computer program 21, and a request 27. The request 27 comprises one or more access request parameters 25.

Although the memory 28 is illustrated as a single component it may be implemented as one or more separate components some or all of which may be integrated/removable and/or may provide permanent/semi-permanent/ dynamic/cached storage.

In the FIG. 4B implementation, the computer program 21 comprising computer program instructions 23 controls the operation of the second apparatus 200 when loaded into the processing circuitry 29. The computer program instructions 21 provide the logic and routines that enables the second apparatus 200 to perform aspects of the method illustrated in FIG. 3. The processing circuitry 29 by reading the memory 28 is able to load and execute the computer program 21.

The computer program 21 may arrive at the second apparatus 200 via any suitable delivery mechanism 54. The delivery mechanism 54 may be, for example, a computer-readable storage medium, a computer program product, a memory device, a record medium such as a CD-ROM or DVD, an article of manufacture that tangibly embodies the computer program 21. The delivery mechanism 54 may be a signal configured to reliably transfer the computer program 21. The second apparatus 200 may propagate or transmit the computer program 21 as a computer data signal.

FIG. 4C illustrates a further example of a third apparatus 800/900. The third apparatus 800/900 illustrated in FIG. 4C comprises the apparatus 30 illustrated in FIG. 1C, transceiver circuitry 36 and a memory 38. In the FIG. 4C example, the reference numerals 800 and 900 denote a support node for a radio communications network. The reference numeral 30 denotes a chip or a chipset in the form of processing circuitry. The processing circuitry 30 is configured to provide an output to and receive an input from the transceiver circuitry 36. The processing circuitry 30 is also configured to read from and write to the memory 38.

The transceiver circuitry 36 may be configured to transmit and receive radio signals and/or wired signals. The radio signals may be short range radio signals or long range radio signals. The transceiver circuitry 36 is configured to operate as a transmitter and a receiver.

The memory 38 is illustrated in FIG. 4C as storing a computer program 31, one or more access control parameter(s) and a request 27. The request comprises one or more access request parameters 25.

Although the memory 38 is illustrated as a single component it may be implemented as one or more separate components some or all of which may be integrated/removable and/or may provide permanent/semi-permanent/ dynamic/cached storage.

In the FIG. 4B implementation, the computer program 31 comprising computer program instructions 33 controls the operation of the third apparatus 800/900 when loaded into the processing circuitry 30. The computer program instructions 31 provide the logic and routines that enables the third apparatus 800/900 to perform aspects of the method illustrated in FIG. 3. The processing circuitry 30 by reading the memory 38 is able to load and execute the computer program 31.

The computer program 31 may arrive at the third apparatus 800/900 via any suitable delivery mechanism 56. The delivery mechanism 56 may be, for example, a computer-readable storage medium, a computer program product, a memory device, a record medium such as a CD-ROM or DVD, an article of manufacture that tangibly embodies the computer program 31. The delivery mechanism 56 may be a signal configured to reliably transfer the computer program 31. The third apparatus 800/900 may propagate or transmit the computer program 31 as a computer data signal.

FIG. 5 illustrates a system including the first and second apparatus 100, 200, a first support node 800 of a radio communications network 700, a second support node 900 of the radio communications network 700 and a server 300.

In this example, the first and second support nodes 800, 900 provide access points to the radio communications network 700. The server 300 is operatively connected to the first support node 800 and the second support node 900.

Exemplary embodiments of the invention will now be described in relation to a social networking service that is provided by the server 300. Alternatively, the service may be provided by one or more of the support nodes 800, 900. In this particular example, the social networking service relates to dating or a secret club.

In this example, the first and second support nodes 800, 900 and the first and second apparatuses 100, 200 operate in accordance with an 802.11 IEEE protocol. However, it will be apparent to those skilled in the art that other appropriate radio protocols could be used, such as Bluetooth.

The users of the first apparatus 100 and the second apparatus 200 are members of the social networking service provided by the server 300. The control circuitry 14 of the first apparatus 100 controls the transceiver circuitry 16 to transmit a first signal 60 to the first support node 800.

The first signal 60 includes service information 15 relating to the social networking service. In this example, the service information 15 included in the first signal 60 identifies that the user of the first apparatus 100 is a (potential) participant in the social networking service.

The service information 15 provided in the first signal 60 may, for example, include user profile data identifying one or more characteristics of a user/owner of the first apparatus 100. For instance, the identified characteristics may include: his or her sex, age, height, weight, eye color, hair color, schools and colleges attended, current job role etc. Alternatively, the user profile data may be transmitted to the first support node 800 in a separate signal to the first signal 60.

In this example, the first signal 60 also includes one or more identifiers 19 and one or more access control parameters 17. In this example, the one or more identifiers 19 include one or more addresses identifying the first apparatus 100.

The access control parameter(s) 17 define how access to the service information 15 is to be controlled by the support nodes 800, 900 of the radio communications network 700. The one or more access control parameters 17 define one or more conditions to be fulfilled, in order for a support node 800, 900 to transmit the service information 15 to an apparatus.

In this example, the one or more conditions specify that another apparatus must provide user profile data that indicates that the owner/user of that apparatus has one or more particular characteristics, in order to receive some or all of the service information 15. In this instance, the user/owner of the first apparatus 100 is interested in meeting people that attended the same college as him. The conditions defined by the access control parameter(s) 17 therefore specify that in order for a person to receive some or all of the service information 15 provided by the first apparatus 100, that person must have attended the same college as the owner of the first apparatus 100 (as identified in the service information 15).

After the service information 15 and the access control parameter(s) 17 have been transmitted to the first support node 800, in this example, the control circuitry 14 controls the transceiver circuitry 16 to transmit second signals 40 periodically. In this example, the second signals 40 are radio signals. The radio signals include the one or more identifiers 19 (that were previously transmitted to the first support node 800) identifying the first apparatus 100.

In this example, the radio signals also include first data that indicates that the first apparatus 100 is connected to a support node 800, second data that indicates that the first apparatus 100 is a potential participant in a service (for example, without necessary identifying the nature of that service) and third data that indicates that service information 15, relating to the service and the first apparatus 100, has been transmitted to a support node 800.

The radio signals 40 may, for example, be beacons. For example, the beacons could be 802.11 IEEE beacon frames and the one or more identifiers 19, the first data, the second data and the third data may be provided in one or more information elements.

The second apparatus 200 receives a radio signal 40 transmitted by the first apparatus 100. In this example, the radio signal 40 is transmitted using data link layer signaling. That is, in this example, there is no network layer connection between the first apparatus 100 and the second apparatus 200. In this example there is no need for a network layer connection to be set up between the first and second apparatuses 100, 200.

The detection circuitry 22 of the second apparatus 200 detects the first apparatus 10 from the received radio signal 40 including the one or more identifiers 19.

The control circuitry 22 of the second apparatus 200 controls the transceiver circuitry 26 to transmit a signal 50, using data link layer signaling, to the second support node 900. At this stage there is no network layer connection between the second apparatus 200 and the second support node 900.

The signal 50 includes a request 27. In this particular example, the request 27 comprises data requesting access to service information 15 associated with the first apparatus 100.

In this particular example, the request 27 includes the one or more identifiers 19 received from the first apparatus 100.

In this example, the request 27 also includes one or more access request parameters 25. The access request parameters 25 identify one or more user profile characteristics of the owner/user of the second apparatus 200. In this example, one of the user profile characteristics identified by the access request parameters 25 indicates that the owner/user of the second apparatus 200 attended the same college as the owner/user of the first apparatus 100.

The transceiver circuitry 36 of the second support node 900 receives the signal 50 from the second apparatus 200. The service information 15 was transmitted to the first support node 800 by the first apparatus 10. In this particular example, the service information 15 is stored at the first support node 800 but not the second support node 900. Consequently, in this example, the second support node 900 transmits a request to the first support node 800, requesting the service information 15 associated with the first apparatus 100. In response, the first support node 800 provides the relevant service information 15 to the second support node 900, along with the associated access control parameters 17.

The decision circuitry 34 of the second support node 900 then uses the access control parameters 17 and the access request parameters 25 included in the request 27 to determine whether to transmit at least some of the service information 15, associated with the first apparatus 100, to the second apparatus 200.

In this example, the decision circuitry 34 determines that the access request parameters 17 supplied by the second apparatus 200 satisfy the condition defined by the access control parameters 17. This is because the access request parameters 25 indicate that the user of the second apparatus 200 attended the same college as the user of the first apparatus 100. Consequently, the second support node 900 enables the second apparatus 200 to access at least some of the service information 15 stored at the second support node 900. FIG. 5 illustrates a signal 70 showing at least some of the service information 15 being transmitted, via data link layer signaling, to the second apparatus 200.

For instance, in the above example, the request 27 may be transmitted to determine whether the first apparatus 100 is a potential participant in the social networking service. The signal 50 may include an indicator indicating that the second apparatus 200 is interested in the social networking service.

The service information 15 that is transmitted in the signal 70 by the second support node 900 may, for example, merely indicate that the second apparatus 200 is a potential participant in the social networking service. That is, the signal 70 need not include all of the service information 15 provided by the first apparatus 100 (such as the user profile data).The user profile data may, for example, be provided to the second apparatus 200 in a subsequent signal.

Once the user of the second apparatus 200 is aware that the second apparatus 200 is a potential participant in the social networking service, he decides whether he would like to participate in the social networking service with the user of the first apparatus 100. If so, in this example, the first apparatus 100 establishes a network layer connection with the second support node 900. The established network layer connection provides the first apparatus 100 with a communication link to the server 300, which may be used to participate in the social networking service. The user profile data that is associated with the user of the second apparatus 200 may, for example, be provided to the first apparatus 100 (by the second support node 900) once the network layer connection has been established.

In an alternative example of the invention to that described above, a number of apparatuses may provide “service information” to a support node 800, 900 by indicating that they are potential participants in one or more services.

In this alternative example, the request 27 may be transmitted by the second apparatus 200 to determine, from the second support node 900, which services are available (or which participants in a service are available). The request 27 need not be specifically related to any one apparatus (such as the first apparatus 100). For example, the request 27 need not include any identifiers relating to a particular apparatus (such as the first apparatus 100).

In this alternative example, in response to receiving the request 27 from the second apparatus 200, the second support node 900 may transmit a signal to the second apparatus 200 that includes a list of available services or potential participants (apparatuses) in one or more services. The signal can be thought of as comprising multiple items of “service information”, where each item is an entry in the list.

The inclusion of an apparatus in the list may depend upon the access control parameters provided by that apparatus and the access request parameters supplied by the second apparatus 200.

In some embodiments of the invention, the service may not be a social networking service provided by the server 300. Instead, the service may be a service provided at the second apparatus 200. Also, the service may be a different service, such as a printing or displaying service.

In the embodiments of the invention described above, the second apparatus 200 may indicate in the radio signal 40 that it is a potential participant in a service, without identifying the nature of that service in the radio signal 40. Thus, advantageously, the first apparatus 100 could be a subscriber to a dating service or a secret club service without having to identify this in the radio signal 40.

For example, it may be that the nature of the service that the first apparatus 100 is a subscriber of is not apparent to the user of the second apparatus 200 until the radio signal 70 is received by the second apparatus 200.

Another advantage of embodiments of the invention is that the support nodes 800, 900 provide some level of security over the service information 15 uploaded by the first apparatus 100. For example, access to the service information 15 is denied if the condition(s) defined by the access control parameters 17 (uploaded by the first apparatus 100) are not satisfied.

A further advantage of embodiments of the invention is that it is not necessary for the second apparatus 200 to establish a network layer connection with a support node 800, 900 in order to download service information.

Implementation of the processing circuitry 14, 22, 24, 30 referred to above can be in hardware alone, have certain aspects in software including firmware alone or can be a combination of hardware and software (including firmware).

References to ‘computer-readable storage medium’, ‘computer program product’, ‘tangibly embodied computer program’ etc. or ‘processing circuitry’, ‘control circuitry’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

Although embodiments of the present invention have been described in the preceding paragraphs with reference to various examples, it should be appreciated that modifications to the examples given can be made without departing from the scope of the invention as claimed. For example, the functionality provided by one or more of the support nodes 800, 900 and the server 300 may be implemented in a single device. Also, the radio signal 40 transmitted by the first apparatus 100 (and received by the second apparatus 200) need not be a broadcast beacon frame. Instead, the radio signal 40 may be a response to a Probe.Request message transmitted by the first apparatus 100.

In the embodiments of the invention described above in relation to FIG. 5, the first apparatus 100 uploads service information 15 and access control parameters 17 to a first support node 800. The access control parameters 17 may specify one or more conditions that a user of a further apparatus must have in order to access the uploaded service information 15. In some embodiments of the invention, the server 300 may make a reservation with a support node, so that if a further apparatus belonging to a user having those characteristics connects to that support node, the support node transmits a signal to the further apparatus identifying the service and/or the first apparatus 100.

In the embodiments of the invention described above, the second apparatus 200 downloads the service information 15 from the second support node 900. The service information 15 may also be downloadable directly from the first support node 800.

In some embodiments of the invention, the signals 50, 60 and 70 are not exchanged directly with the first and second support nodes 800, 900 as described above. Instead, the signals 50, 60, 70 are provided to/from the support nodes 800, 900 via an intermediary, such as a server.

In some exemplary embodiments of the invention, the second apparatus 200 may also upload service information to a support node 800, 900. When making the request requesting service information relating to the first apparatus 100, the second apparatus 200 may also transmit one or more identifiers identifying the second apparatus 200 (such as an address of the second apparatus 200). The identifier(s) relating to the second apparatus 200 may then be provided to the first apparatus 100 via the first support node 800. The first apparatus 100 may use the identifier(s) to download the service information relating to the second apparatus 200. Thus, in these examples, it is not necessary for the first apparatus 100 to receive a radio signal from the second apparatus 200 (that includes an identifier relating to the second apparatus 200) in order for the first apparatus 100 to download service information relating to the second apparatus 200.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A method, comprising:
controlling a transmitter of an apparatus to transmit a request, to a further apparatus via data link layer signaling, requesting access to service information relating to at least one service and provided to the further apparatus by at least one other apparatus, wherein the request comprises at least one access request parameter.

2. A method as claimed in claim 1, further comprising detecting the at least one other apparatus from a radio signal transmitted by the another apparatus.

3. A method as claimed in claim 1, further comprising controlling the transmitter to transmit at least one identifier identifying the at least one other apparatus.

4. A method as claimed in claim 1, further comprising controlling the transmitter to transmit at least one indicator indicating at least one service of interest to the apparatus.

5. A method as claimed in claim 1, wherein the further apparatus is a support node of a radio communications network.

6. A method as claimed in claim 1, further comprising receiving the service information from the further apparatus.

7. A method as claimed in claim 1, further comprising receiving communication information for enabling communication with a service provider of the at least one service.

8-10. (canceled)

11. An apparatus, comprising:
at least one memory for storing at least one access request parameter; and
control circuitry configured to control a transmitter to transmit a request, to a further apparatus via data link layer signaling, requesting access to service information relating to at least one service and provided to the further apparatus by at least one other apparatus, wherein the request comprises the at least one access request parameter.

12. An apparatus as claimed in claim 11, further comprising detection circuitry configured to detect the at least one other apparatus from a radio signal transmitted by the another apparatus.

13. An apparatus as claimed in claim 11, wherein the control circuitry is configured to control the transmitter to transmit at least one identifier identifying the at least one other apparatus.

14. An apparatus as claimed in claim 11, wherein the control circuitry is configured to control the transmitter to transmit at least one indicator indicating at least one service of interest to the apparatus.

15. An apparatus as claimed in claim 11, wherein the further apparatus is a support node of the a radio communications network.

16. An apparatus as claimed in claim 11, further comprising a receiver configured to receive the service information from the further apparatus.

17. An apparatus as claimed in claim 11, further comprising a receiver configured to receive communication information for enabling communication with a service provider of the at least one service.

18-24. (canceled)

25. A method, comprising:
controlling a transmitter of an apparatus to transmit, to a further apparatus, service information relating to at least one service; and
controlling the transmitter of the apparatus to transmit, to the further apparatus, at least one access control parameter that defines how to control access, via data link layer signaling, to the service information relating to the at least one service.

26. A method as claimed in claim 25, wherein the service information is associated with at least one of: the apparatus and the user of the apparatus.

27. A method as claimed in claim 25, wherein the apparatus is a potential participant in the at least one service.

28. A method as claimed in claim 25, wherein the further apparatus is a support node of a radio communications network.

29. A method as claimed in claim 25, wherein the at least one access control parameter defines one or more conditions to be fulfilled, in order for another apparatus to be granted access to the service information stored at the further apparatus.

30. A method as claimed in claim 25, wherein the at least one access control parameter defines one or more conditions to be fulfilled, in order for the further apparatus to transmit the service information, via data link layer signaling, to another apparatus.

31. A method as claimed in claim 25, wherein at least one of the apparatus and a server provides the at least one service.

32-33. (canceled)

34. An apparatus, comprising:
at least one memory for storing at least one access control parameter that defines how to control access to service information relating to at least one service;
control circuitry configured to control a transmitter to transmit, to a further apparatus, the service information relating to the at least one service,
wherein the control circuitry is further configured to control the transmitter to transmit, to the further apparatus, the at least one access control parameter that defines how to control access, via data link layer signaling, to the service information relating to the at least one service.

35. An apparatus as claimed in claim 34, wherein the service information is associated with at least one of: the apparatus and a user of the apparatus.

36. An apparatus as claimed in claim 34, wherein the apparatus is a potential participant in the at least one service.

37. An apparatus as claimed in claim 34, wherein the further apparatus is a support node of a radio communications network.

38. An apparatus as claimed in claim 34, wherein the at least one access control parameter defines one or more conditions to be fulfilled, in order for the further apparatus to transmit the service information, via data link layer signaling, to another apparatus.

39-46. (canceled)

47. A method, comprising:
determining, from at least one access control parameter provided by a first apparatus, how to control access to service information provided by the first apparatus; and
deciding, in response to reception of a request from a second apparatus requesting access to service information, whether to enable the second apparatus to access service information provided by the first apparatus, wherein the decision is dependent upon the at least one access control parameter; and
in response to deciding to enable the second apparatus to access service information provided by the first apparatus, controlling a transmitter to transmit, via data link layer signaling, that service information to the second apparatus.

48. A method as claimed in claim 47, further comprising controlling the transmitter to transmit communication information for enabling the second apparatus to communicate with a service provider of the at least one service.

49. A method as claimed in claim 47, wherein the service provider of the at least one service is at least one of the first apparatus and an apparatus that is different from the first apparatus.

50. (canceled)

51. A method as claimed in claim 47, wherein the at least one access control parameter defines one or more conditions to be fulfilled, in order for an apparatus to be granted access to service information provided by the first apparatus.

52. A method as claimed in claim 47, wherein deciding whether to enable the second apparatus to access service information provided by the first apparatus comprises determining whether the at least one access request parameter fulfills the one or more conditions defined by the at least one access control parameter.

53. (canceled)

54. An apparatus, comprising:
determination circuitry configured to determine from at least one access control parameter provided by a further apparatus, how to control access to service information provided by the further apparatus;
decision circuitry configured to decide, in response to reception of a request from another apparatus requesting access to service information, whether to enable the another apparatus to access service information provided by the further apparatus, wherein the decision is dependent upon the at least one access control parameter; and
control circuitry configured, in response to the decision circuitry deciding to enable the another apparatus to access service information provided by the further apparatus, to control a transmitter to transmit, via data link layer signaling, that service information to the another apparatus.

55. An apparatus as claimed in claim 54, wherein the control circuitry is configured to control the transmitter to transmit communication information for enabling the another apparatus to communicate with a service provider of the at least one service.

56. (canceled)

57. An apparatus as claimed in claim 55, wherein the service provider of the at least one service is at least one of the further apparatus and an apparatus that is different from the further apparatus.

58. An apparatus as claimed in claims 54, wherein the at least one access control parameter defines one or more conditions to be fulfilled, in order for an apparatus to be granted access to service information provided by the further apparatus.

59. An apparatus as claimed in claim 54, wherein the decision circuitry is configured to decide whether to enable the another apparatus to access service information provided by the further apparatus, by determining whether the at least one access request parameter fulfills the one or more conditions defined by the at least one access control parameter.

60-68. (canceled)
